(19) United States
(12) Patent Application Publication
(10) Pub. No.: US 2004/0259007 A1
(43) Pub. Date: Dec. 23, 2004

(54) Electroconductive composition, electroconductive coating and method for forming electroconductive coating

(76) Inventors: Katsuhiko Takahashi, Sakura-shi (JP); Kiwako Ohmori, Sakura-shi (JP); Masanori Endo, Sakura-shi (JP); Hikaru Yasuhara, Tokyo (JP); Akinobu Ono, Tokyo (JP); Takayuki Imai, Sakura-shi (JP); Yukihiko Kurosawa, Tokyo (JP); Hiroaki Zaima, Kyoto-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/500,124

(22) PCT Filed: Dec. 25, 2002
(86) PCT No.: PCT/JP02/13502

(30) Foreign Application Priority Data
Dec. 27, 2001 (JP) 2001-398425
Apr. 17, 2002 (JP) 2002-115438

(51) Int. Cl. G03C 5/00

(52) U.S. Cl. 430/8

(57) ABSTRACT

An electrically conductive composition can be obtained that provides an electrically conductive coating having low volume resistivity and high electrical conductivity comparable to that of metallic silver independent of high-temperature film deposition conditions, while also enabling the line width of an electrical circuit to be sufficiently narrow without having to increase thickness in the case of forming an electrical circuit of a flexible circuit board and so forth.

An electrically conductive composition is formed with a composition composed of a particulate silver compound, a reducing agent and optionally a dispersion medium. Silver oxide, silver carbonate or silver acetate and so forth is used for the particulate silver compound. Water or alcohol, for example, is used for the dispersion medium, and ethylene glycol or diethylene glycol and so forth is used for the reducing agent. In addition, the average particle diameter of the particulate silver compound is preferably about 0.01-10 μm.

### TECHNICAL FIELD

The present invention relates to an electrically conductive composition used as, for example, an electrically conductive paste, electrically conductive paint or electrically conductive adhesive, a method for forming an electrically conductive coating that uses this electrically conductive composition, and an electrically conductive coating obtained with this formation method, and is capable of adequately enhancing the electrical conductivity of the resulting electrically conductive coating to obtain electrical conductivity that approaches that of metallic silver.

### BACKGROUND ART

A typical example of an electrically conductive paste of the prior art consisted of a silver paste obtained by blending and kneading a thermoplastic resin such as acrylic resin or vinyl acetate resin, a binder composed of a thermosetting resin such as epoxy resin or polyester resin, an organic solvent, a curing agent and a catalyst and so forth into flaked silver particles.

This silver paste is widely used as an electrically conductive adhesive or electrically conductive paint in various types of electronic equipment, electronic components, electronic circuits and so forth. In addition, this silver paste is also used as in a flexible printed circuit board, keyboard, various types of switches and other printed circuit boards printed by screen printing and so forth onto a plastic film such as a polyethylene terephthalate film.

This silver paste is used by coating onto a target object by various types of coating methods, and then drying at ordinary temperatures or heating to about 150° C. to obtain an electrically conductive coating.

Although varying according to the conditions of film deposition, the volume resistivity of an electrically conductive coating obtained in this manner is within the range of 10⁻⁴ to 10⁻⁵ Ω·cm, which is 10-100 times greater than the volume resistivity of metallic silver of 1.6×10⁻⁶ Ω·cm, thus preventing it from attaining the level of electrical conductivity of metallic silver.

The reason for the low electrical conductivity of an electrically conductive coating composed of silver past as in the prior art is that, within an electrically conductive coating obtained from silver paste, only a portion of the silver particles make physical contact thereby resulting in a low number of contact points, there is contact resistance at the contact points, and binder remains between a portion of these silver particles, thereby allowing this binder to impede direct contact between the silver particles.

An example of a method for improving the low level of electrical conductivity of this silver paste consists of coating the silver paste onto a target object, heating to about 800° C. to remove the binder by incineration while also melting the silver particles, and fusing the silver particles to form a uniformly continuous metallic silver coating. The volume resistivity of an electrically conductive coating obtained in this manner is about 10⁻⁶ Ω·cm, which is close to that of metallic silver.

However, this method has the disadvantage of the target object being limited to heat-resistant materials such as glass, ceramics and porcelain that can withstand high-temperature heating.

In addition, in the aforementioned flexible circuit board, it is required to make the line width of the electrical circuit formed thereon as narrow as possible. However, since silver particles used in conventional silver paste are in the form of flakes having a particle diameter of 1-100 μm, it is theoretically impossible to print a circuit having a line width equal to or less than the particle diameter of the flaked silver particles.

Moreover, despite the need to make the line width of electrical circuit as narrow as possible, it is also necessary to simultaneously provide adequate electrical conductivity, and it is necessary to make the thickness of the electrical circuit quite thick in order to meet this requirement. However, when the thickness of an electrical circuit is increased, film deposition becomes increasingly difficult while also resulting in the problem of considerably lowering the flexibility of the circuit itself.

Accordingly, an object of the present invention is to obtain an electrically conductive composition that allows the obtaining of an electrically conductive coating having low volume resistivity and high electrical conductivity comparable to that of metallic silver independent of high-temperature film deposition conditions, while also enabling the line width of an electrical circuit to be sufficiently narrow without it being necessary to increase thickness in the case of forming an electrical circuit of a flexible circuit board and so forth.

### DISCLOSURE OF THE INVENTION

In order to solve the aforementioned problems, the electrically conductive composition of the present invention is composed of a particulate silver compound and a reducing agent. Silver oxide, silver carbonate or silver acetate and so forth can be used for the particulate silver compound. The average particle diameter of the particulate silver compound is 0.01-10 μm. The reducing agent is a reducing agent such as ethylene glycol.

The electrically conductive coating formation method of the present invention consists of coating an electrically conductive composition followed by heating.

The electrically conductive coating of the present invention is obtained by the aforementioned formation method, consists of mutually fused silver particles, and has a volume resistivity of 3-8×10⁻⁶ Ω·cm. In addition, this electrically conductive coating, when obtained by coating the aforementioned electrically conductive composition followed by heating for 30 minutes at 150-200° C. satisfies the following formula (1) when W represents the volume resistivity (Ω·cm) of the electrically conductive coating and X represents its specific gravity.

W≦−1.72×10⁻⁶×X+2.3×10⁻⁵ (1)

Moreover, this electrically conductive coating, when obtained by coating the aforementioned electrically conductive composition followed by heating for 30 minutes at 150-200° C. satisfies the following formula (2) when Y represents the number of pores of 100 nm or larger present in a surface area of 10 μm×10 μm on the uppermost surface of the electrically conductive coating, and Z represents the heating temperature (° C.).

Y<−46.08·Z+10112 (2)

The particulate silver compound is easily reduced to metallic silver particles by heating in the presence of the reducing agent, and the precipitated metallic silver particles melt due to the heat of reaction during this reduction reaction causing them to mutually fuse and form a metallic silver coating having high electrical conductivity. Consequently, the resulting electrically conductive coating demonstrates electrical conductivity comparable to that of metallic silver.

### BRIEF DESCRIPTION OF THE DRAWINGS

FIG. 1 is a scanning electron micrograph of the surface of an electrically conductive coating obtained from the electrically conductive composition of the present invention.

FIG. 2 is a scanning electron micrograph of the surface of an electrically conductive coating obtained from a silver paste of the prior art.

FIG. 3 is a graph showing the relationship between volume resistivity and specific gravity of an electrically conductive coating in a specific example.

FIG. 4 is a graph showing the relationship between the number of surface pores and heating temperature of an electrically conductive coating in a specific example.

### BEST MODE FOR CARRYING OUT THE INVENTION

The following provides a detailed explanation of the present invention.

The particulate silver compound used in the electrically conductive composition of the present invention is a compound in the form of solid particles that has the property of becoming metallic silver when reduced by heating in the presence of a reducing agent.

Specific examples of this particulate silver compound include silver oxide, silver carbonate and silver acetate. Two or more types of these compounds may be used by mixing. This particulate silver compound can use an industrially produced particulate silver compound either directly or after grading, or it can be used after being crushed and graded. In addition, a particulate silver compound may be used that has been obtained by a liquid phase method or vapor phase method to be described later.

The average particle diameter of this particulate silver compound is within the range of 0.01-10 μm, and can be suitably selected according to the conditions of the reduction reagent such as the heating temperature and reducing strength of the reducing agent. In particular, the use of a particulate silver compound having an average particle diameter of 0.5 μm or less is preferably since this increases the rate of the reduction reaction.

In addition, a particular silver compound having an average particle diameter of 0.5 μm or less can be produced by a liquid phase method in which silver oxide is obtained by reacting an aqueous alkaline solution such as aqueous sodium hydroxide solution with the product of the reaction with a silver compound and another compound such as an aqueous silver nitrate solution by dropping in while stirring. In this case, a dispersion stabilizer is preferably added to the solution to prevent aggregation of the precipitated particulate silver compound. In this liquid phase method, the particle diameter can be controlled by changing the silver compound concentration, dispersion stabilizer concentration and so forth.

In addition, a vapor phase method can be used to obtain a particulate silver compound having an average particle diameter of 0.1 μm or less by synthesizing silver oxide by heating a silver halide and oxygen in the vapor phase followed by thermal oxidation.

The reducing agent used in the present invention is capable of reducing the aforementioned particulate silver compound, and its reaction byproduct following the reduction reaction is preferably a gas or highly volatile liquid which does not remain in the electrically conductive coating that is formed. Specific examples of such reducing agents include ethylene glycol, diethylene glycol, triethylene glycol and ethylene glycol diacetate, and one type or two or more types may be used as a mixture.

The amount of this reducing agent used is 20 moles or less, preferably 0.5-10 moles, and more preferably 1-5 moles, with respect to 1 mole of particulate silver compound. When considering reaction efficiency and volatilization by heating, although it is preferable that the amount used be greater than the equimolar amount, addition in excess of the maximum amount of 20 moles ends up being wasteful.

In addition, a dispersion medium is used to disperse or dissolve the particulate silver compound and reducing agent and obtain a liquid electrically conductive composition. Organic solvents such as water, alcohols such as methanol, ethanol and propanol or isophorone, terpineol, triethylene glycol monobutyl ether or butyl cellosolve acetate are used for this dispersion medium.

In addition, in the case the aforementioned reducing agent is a liquid and the particulate silver compound is dispersed, the reducing agent is also able to serve as a dispersion medium, and examples of such a reducing agent include ethylene glycol and diethylene glycol.

Selection of the type of dispersion medium and the amount used vary according to the particulate silver compound and film deposition conditions, for example the mesh coarseness of the screen and the fineness of the printing pattern in the case of screen printing, and are suitably adjusted to as to enable optimum film deposition.

In addition, secondary aggregation of the particulate silver composition is preferably prevented by adding a dispersant and satisfactorily dispersing a particulate silver compound having an average particle diameter of 1 μm or less. Dispersants such as hydroxypropyl cellulose, polyvinyl pyrrolidone and polyvinyl alcohol are used for this dispersant, and the amount used is 0-300 parts by weight to 100 parts by weight of particulate silver compound.

The electrically conductive composition of the present invention consists of dispersing and dissolving the aforementioned particulate silver compound and reducing agent. In addition, a dispersant may also be added as necessary. The average particle diameter of the particulate silver compound used here has no lower limit, that within a range of 0.01-10 μm does not cause any particular problems, and the reduction reaction proceeds smoothly even in the case of particles of 1 μm or larger.

In addition, although varying according to the conditions of film deposition, the viscosity of this electrically conductive composition is preferably 30-300 poise in the case of, for example, screen printing.

The usage method of this electrically conductive composition, namely the formation method of the electrically conductive coating of the present invention, consists of coating this composition onto a target object by a suitable means, followed by simply by heating. The heating temperature is 140-160° C. depending on the presence of reducing agent, and the heating time is roughly from 10 seconds to 120 minutes.

Furthermore, the surface of the target object is naturally cleaned before coating.

In an electrically conductive coating of the present invention obtained in this manner, the particulate silver compound is reduced, and the reduced metallic silver particles mutually fuse to form a continuous, metallic silver thin coating.

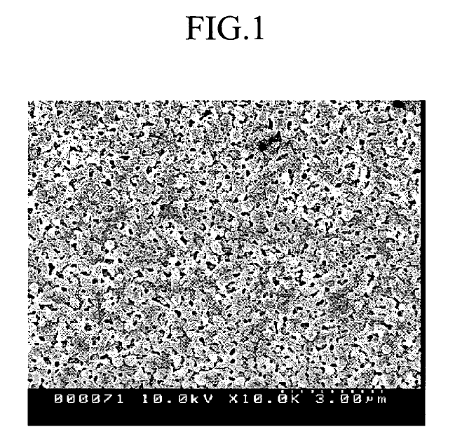

FIG. 1 is a scanning electron micrograph showing an example of an electrically conductive coating obtained in this manner. As is clear from this micrograph, the coating can be understood to be in the form of a continuous coating of metallic silver.

Consequently, the volume resistivity of the electrically conductive coating of the present invention demonstrates a value that reaches 3-8×10⁻⁶ Ω·cm, which is on the same order as the volume resistivity of metallic silver.

In addition, since the average particle diameter of the particulate silver compound is 0.01-10 μm, the line width of an electrical circuit formed by printing this electrically conductive composition on a base material can be made to be 10 μm or less, and since the electrical conductivity of the circuit itself is extremely high, it is not necessary to increase the thickness of the circuit. Consequently, a circuit can be formed easily and the circuit itself has a high degree of flexibility.

Moreover, since the heating temperature for forming an electrically conductive coating only requires a temperature of 140-160° C., the present invention can be applied to target objects such as plastic film having a low level of heat resistance, which together with allowing the formation of a highly electrically conductive coating, does not lead to thermal degradation of the target object.

Moreover, since the volume resistivity of the resulting electrically conductive coating is extremely low, sufficient electrical conductivity can be obtained even if the thickness of the coating is extremely thin. The coating thickness can be reduced by an amount corresponding to the decrease in volume resistivity relative to an electrically conductive paste of the prior art. For example, in the case of having used a silver paste having volume resistivity of 5×10⁻⁵ Ω·cm, since volume resistivity of 3×10⁻⁶ Ω·cm can be realized by the present invention in the case of specifications requiring a circuit having a thickness of 50 μm, the electrically conductive coating can be made to have a thickness of 3 μm.

In addition, since the surface on the base material side of the resulting electrically conductive coating presents a mirrored surface rich in the luster of metallic silver, the back surface of a plastic film or other transparent base material or the top surface on the side of the base material of an electrically conductive coating separated from the base material can be used in household and industrial applications as a mirror offering a high level of reflectance, such as in a reflecting mirror of the resonator of a laser device.

In addition, the following relationship was clearly demonstrated to be valid with respect to an electrically conductive coating obtained from the electrically conductive composition of the present invention.

Namely, when the volume resistivity and specific gravity were measured for an electrically conductive coating obtained by coating the aforementioned electrically conductive composition onto a glass plate or other base material followed by heating for 30 minutes at 150-200° C. to determine the relationship between these two parameters, the aforementioned formula (1) was clearly determined to be satisfied when W represents the volume resistivity (Ω·cm) of the electrically conductive coating and X represents its specific gravity.

Thus, a satisfactory electrically conductive coating can be obtained by defining the specific gravity of the resulting electrically conductive coating so that its volume resistivity is lower than the value of formula (1).

In addition, when the number of pores present per unit surface area in the uppermost surface of an electrically conductive film obtained in the same manner were determined by observing with a scanning electron microscope to determine the relationship between the number of pores and heating temperature, the aforementioned formula (2) was clearly determined to be satisfied when Y represents the number of pores of 100 nm or larger present over a surface area of 10 μm×10 μm in the uppermost surface of the electrically conductive coating, and Z represents the heating temperature (° C.).

On the basis of this relationship, it was found that the heating temperature should be suitably controlled to form a satisfactory electrically conductive coating having few pores, and that an electrically conductive film having a small number of pores and a high level of electrical conductivity is obtained by heating at about 180-200° C. The following provides a description of specific examples.

### EXAMPLE 1

0.17 g of silver nitrate were dissolved in 50 ml of ion exchange water followed by dissolving 0.05-0.5 g of hydroxypropyl cellulose (dispersant) therein to prepare an aqueous solution. 0.9-5 ml of a 1 M aqueous sodium hydroxide solution were then dropped into this aqueous solution while stirring after which stirring was continued for 10-30 minutes to obtain a silver oxide suspension.

Next, excess ions were removed by washing the silver oxide 2-5 times with methanol. 0.06-1 g of ethylene glycol (reducing agent) were then added and mixed to produce a paste-like electrically conductive composition of the present invention.

After forming this electrically conductive composition into a pattern having a thickness of 5-10 μm on 0.1 mm thick polyethylene terephthalate film by screen printing, the pattern was heated in an oven for 30 minutes to 3 hours at 150° C.

The volume resistivity of the resulting patterns were 3-6×10⁻⁶ Ω·cm, and observation of the surface with a scanning electron microscope revealed that silver particles that had been reduced and precipitated from the silver oxide had fused and joined together as shown in FIG. 1.

### EXAMPLE 2

For the sake of comparison, a commercially available silver paste (Fujikura Kasei, trade name: “FA-353”) was used to form a pattern having a thickness of 5-10 μm on a 0.1 mm thick polyethylene terephthalate film by screen printing followed by heating for 30 minutes at 150° C. in an oven.

The volume resistivity of the resulting pattern was 4×10⁻⁵ Ω·cm, and observation of surface with a scanning electron microscope revealed a state in which the silver flakes were merely making contact.

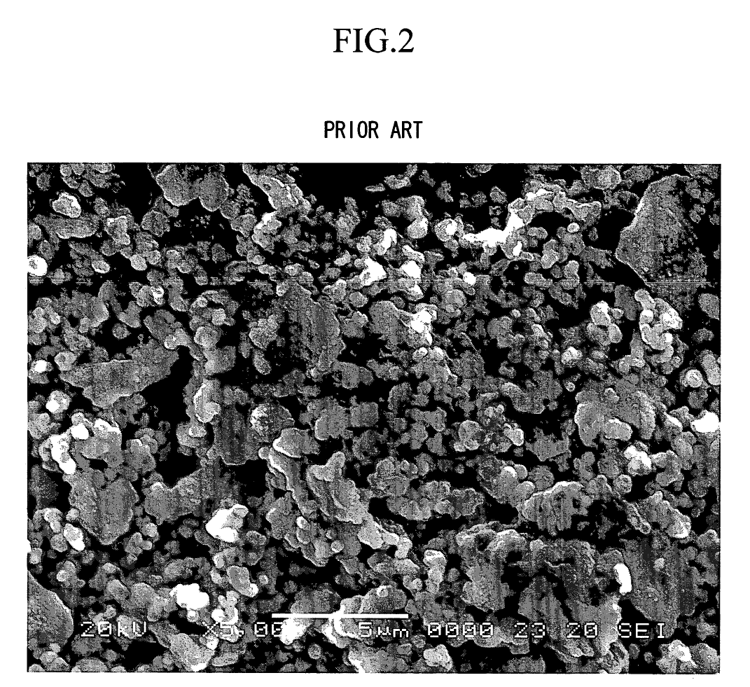

In addition, when a pattern was similarly formed using a different commercially available silver paste (Asahi Kasei Laboratories), the volume resistivity was 3×10⁻⁵ Ω·cm, and observation of the surface with a scanning electron microscope revealed a state in which the silver flakes were merely making contact as shown in the scanning electron micrograph of FIG. 2.

### EXAMPLE 3

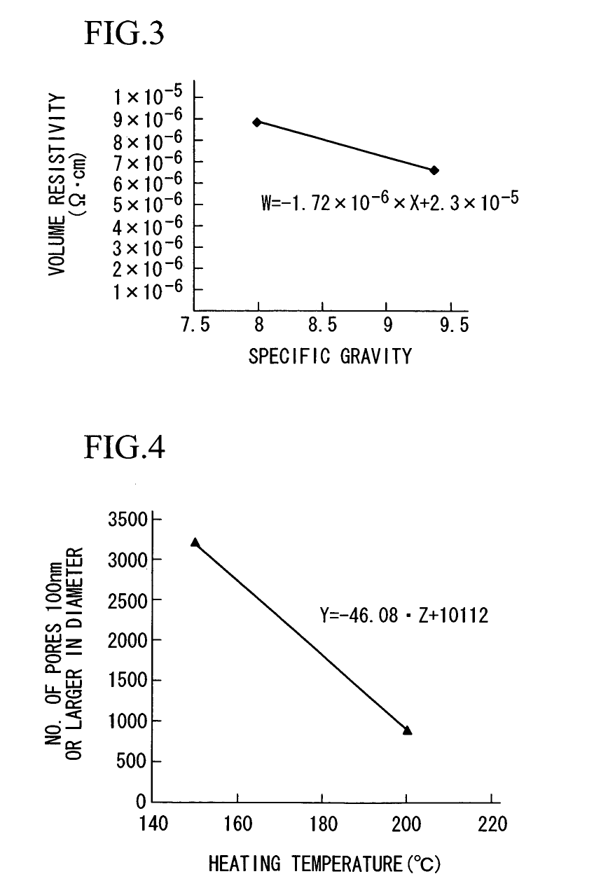

When the electrically conductive composition in the aforementioned Example 1 was coated in an equal amount onto a glass plate to a thickness of 5-10 μm, and then heated in an oven under conditions of 30 minutes at 150° C. and then 30 minutes at 200° C., followed by measuring the volume resistivity and specific gravity of the resulting electrically conductive film to determine their relationship, results like the graph shown in FIG. 3 were obtained.

Determination of a regression formula from this graph yielded the aforementioned formula (1).

In addition, when the surface of an electrically conductive coating produced in the same manner was observed with a scanning electron microscope followed by calculation of the number of pores present in the uppermost surface to determine the relationship between the number of pores and heating temperature, results like the graph shown in FIG. 4 were obtained.

Determination of a regression formula from this graph yielded the aforementioned formula (2).

### EXAMPLE 4

Electronically conductive coatings were formed using 100 parts by weight of silver oxide for the particulate silver compound and 75 parts by weight of ethylene glycol for the reducing agent while changing the average particle diameter of the silver oxide, followed by measurement of volume resistivity. In addition, the presence of fusion of silver particles was also observed with a scanning electron microscope.

Polyethylene terephthalate film having a thickness of 0.1 mm was used for the base material, and binder having a thickness of 5-10 μm was form on this base material by screen printing followed by heating for 30 minutes to 3 hours at 150° C.

Silver oxide having an average particle diameter of 0.01 μm was produced by a vapor phase method, that having an average particle diameter of 0.1-1.5 μm was produced by a liquid phase method, and that having an average particle diameter of 10-15 μm was used by grading commercially available products. The results are shown in Table 1.

TABLE 1

| | Test No. | | | | | | | |
|---|---|---|---|---|---|---|---|---|
| | 1 | 2 | 3 | 4 | 5 | 6 | 7 | 8 |
| Silver | 0.01 | 0.1 | 0.25 | 0.8 | 1.5 | 5 | 10 | 15 |
| oxide | | | | | | | | |
| avg. | | | | | | | | |
| particle | | | | | | | | |
| diameter | | | | | | | | |
| (μm) | | | | | | | | |
| Volume | 3 × 10⁻⁶ | 3 × 10⁻⁶ | 3 × 10⁻⁶ | 5 × 10⁻⁶ | 8 × 10⁻⁶ | 8 × 10⁻⁶ | 8 × 10⁻⁶ | 9 × 10⁻⁵ |
| resistivity | to | to | to | to | to | to | to | to |
| (Ω · cm) | 6 × 10⁻⁶ | 6 × 10⁻⁶ | 7 × 10⁻⁶ | 9 × 10⁻⁶ | 1 × 10⁻⁵ | 1 × 10⁻⁵ | 3 × 10⁻⁵ | 8 × 10⁻⁴ |
| Fusion | Yes | Yes | Yes | Yes | Yes | Yes | Yes | Partial |
| between | | | | | | | | |
| silver | | | | | | | | |
| particles | | | | | | | | |

Based on the results of Table 1, although volume resistivity increases the larger the average particle diameter, if the average particle diameter is within the range of 0.1-10 μm, the volume resistivity is on the order of 10⁻⁶ Ω·cm, thereby allowing the formation of an electrically conductive coating that does not present any problems in terms of practical use.

### EXAMPLE 5

Electrically conductive coatings were formed by using silver oxide having an average particle size of 0.25 μm for the particulate silver compound while changing the types and combinations of reducing agents followed by measurement of volume resistivity. In addition, the presence of fusion of silver particles was also observed with a scanning electron microscope. A total of 75 parts by weight of reducing agent were blended into 100 parts by weight of silver oxide.

Polyethylene terephthalate film having a thickness of 0.1 mm was used for the base material, and a pattern having a thickness of 5-10 μm was formed thereon by screen printing followed by heating for 30 minutes to 3 hours at 150° C.

The results are shown in Table 2.

TABLE 2

| | Test No. | | | | |
|---|---|---|---|---|---|
| | 9 | 10 | 11 | 12 | 13 |
| Type of | Blended Amount (parts by weight) | | | | |
| reducing | | | | | |
| agent | | | | | |
| Ethylene | | | | 32.5 | 32.5 |
| glycol | | | | | |
| Diethylene | 75 | | | 32.5 | |
| glycol | | | | | |
| Triethylene | | 75 | | | |
| glycol | | | | | |
| Ethylene | | | 75 | | 32.5 |
| glycol | | | | | |
| diacetate | | | | | |
| Volume | 3 × 10⁻⁶ to | 5 × 10⁻⁶ to | 5 × 10⁻⁶ to | 3 × 10⁻⁶ to | 5 × 10⁻⁶ to |
| resistivity | 8 × 10⁻⁶ | 1 × 10⁻⁵ | 1 × 10⁻⁵ | 8 × 10⁻⁶ | 9 × 10⁻⁶ |
| (Ω · cm) | | | | | |
| Fusion of | Yes | Yes | Yes | Yes | Yes |
| silver | | | | | |
| particles | | | | | |

Based on the results of Table 2, volume resistivity was on the order of 10⁻⁶ Ω·cm and an electrically conductive coatings were able to be formed that did not present problems in terms of practical use even if the types and combinations of reducing agents were changed.

### EXAMPLE 6

Electrically conductive coatings were produced while changing the types and combinations of particulate silver compounds followed by measurement of volume resistivity. In addition, the presence of fusion of silver particles was also observed with a scanning electron microscope.

Ethylene glycol was used for the reducing agent, and was blended at 75 parts by weight to 100 parts by weight of particulate silver compound.

Polyethylene terephthalate film having a thickness of 0.1 mm was used for the base material, and a pattern having a thickness of 5-10 μm was formed thereon by screen printing followed by heating for 30 minutes to 3 hours at 150° C.

The results are shown in Tables 3 and 4.

TABLE 3

| | Test No. | | | | |
|---|---|---|---|---|---|
| | 14 | 15 | 16 | 17 | 18 |
| Particulate | Silver | Silver | Silver | Silver | Silver |
| silver | carbonate | carbonate | carbonate | acetate | acetate |
| compound | | | | | |
| Avg. | 0.1 | 1.5 | 5 | 5 | 10 |
| particle | | | | | |
| diameter | | | | | |
| (μm) | | | | | |
| Volume | 4 × 10⁻⁶ to | 7.5 × 10⁻⁶ | 8 × 10⁻⁶ to | 6.5 × 10⁻⁶ to | 8 × 10⁻⁶ to |
| resistivity | 7 × 10⁻⁶ | to | 1.2 × 10⁻⁵ | 1 × 10⁻⁵ | 3.4 × 10⁻⁵ |
| (Ω · cm) | | 1 × 10⁻⁵ | | | |
| Fusion of | Yes | Yes | Yes | Yes | Yes |
| silver | | | | | |
| particles | | | | | |

TABLE 4

| | Test No. | | | | | | |
|---|---|---|---|---|---|---|---|
| | 19 | 20 | 21 | 22 | 23 | 24 | 25 |
| Particulate | Silver | Silver | Silver | Silver | Silver | Silver | Silver |
| silver | oxide | oxide | oxide | oxide | carbonate | oxide | oxide |
| compound | | | | | | | |
| Avg. | 0.25 | 0.25 | 0.25 | 5 | 0.35 | 0.25 | 0.25 |
| particle | | | | | | | |
| diameter | | | | | | | |
| (μm) | | | | | | | |
| Blending | 50 | 70 | 50 | 60 | 50 | 33 | 50 |
| ratio (wt %) | | | | | | | |
| Particulate | Silver | Silver | Silver | Silver | Silver | Silver | Silver |
| silver | carbonate | carbonate | acetate | acetate | acetate | carbonate | carbonate |
| compound | | | | | | | |
| Avg. | 0.35 | 5 | 5 | 5 | 5 | 0.35 | 5 |
| particle | | | | | | | |
| diameter | | | | | | | |
| (μm) | | | | | | | |
| Blending | 50 | 30 | 50 | 40 | 50 | 33 | 25 |
| ratio (wt %) | | | | | | | |
| Particulate | — | — | — | — | — | Silver | Silver |
| silver | | | | | | acetate | acetate |
| compound | | | | | | | |
| Avg. | — | — | — | — | — | 5 | 5 |
| particle | | | | | | | |
| diameter | | | | | | | |
| (μm) | | | | | | | |
| Blending | — | — | — | — | — | 34 | 25 |
| ratio (wt %) | | | | | | | |
| Volume | 4 × 10⁻⁶ to | 7 × 10⁻⁶ to | 6.2 × 10⁻⁶ | 8 × 10⁻⁶ | 5.4 × 10⁻⁶ | 4.2 × 10⁻⁶ | 7.9 × 10⁻⁶ |
| resistivity | 6.7⁻⁶ | 8.3 × 10⁻⁶ | to | to | to | to 7 × 10⁻⁶ | to |
| (Ω · cm) | | | 8.5 × 10⁻⁶ | 1.2 × 10⁻⁵ | 9.1 × 10⁻⁶ | | 1.1 × 10⁻⁵ |
| Fusion of | Yes | Yes | Yes | Yes | Yes | Yes | Yes |
| silver | | | | | | | |
| particles | | | | | | | |

Based on the results of Table 3 and Table 4, volume resistivity was on the order of 10⁻⁶ Ω·cm and an electrically conductive coatings were able to be formed that did not present problems in terms of practical use even if silver oxide, silver carbonate, silver acetate or their combinations were changed.

As has been explained above, according to the electrically conductive composition of the present invention, an electrically conductive coating can be obtained that has extremely high electrical conductivity. In addition, since the formation of this electrically conductive coating is sufficiently carried out by heating at a comparatively low temperature, plastic and other materials having a low level of heat resistance can be used for the base material. Moreover, this electrically conductive composition allows the line width of an electrical circuit to be adequately narrow when forming an electrical circuit, and it is not necessary to increase its thickness.

### INDUSTRIAL APPLICABILITY

The electrically conductive composition of the present invention is used as an electrically conductive paste, electrically conductive paint or electrically conductive adhesive and so forth. In addition, it can also be used to form an electrical circuit of a printed wiring board such as a flexible printed circuit board. Moreover, this electrically conductive coating can also be used as a reflective thin film having high reflectance.

1. An electrically conductive composition comprising a particulate silver compound and a reducing agent.

2. An electrically conductive composition according to claim 1, wherein the particulate silver compound comprises one type or two or more types, of silver oxide, silver carbonate and silver acetate.

3. An electrically conductive composition according to claim 1, wherein the average particle diameter of the particulate silver compound is about 0.01-10 μm.

4. An electrically conductive composition according to claim 1, wherein the reducing agent comprises one type, or two or more types, of ethylene glycol, diethylene glycol, triethylene glycol and ethylene glycol diacetate.

5. An electrically conductive coating formation method comprising the step of coating the electrically conductive composition according to claim 1 followed by the step of heating the electrically conductive composition.

6. An electrically conductive coating obtained by coating the electrically conductive composition according to claim 1 followed by heating, wherein the particulate silver compound particles are mutually fused.

7. An electrically conductive coating obtained by coating the electrically conductive composition according to claim 1 followed by heating, wherein the volume resistivity is about 3.0×10⁻⁶ to about 8.0×10⁻⁶ Ω·cm.

8. An electrically conductive coating obtained by coating the electrically conductive composition according to claim 1 followed by heating for about 30 minutes at about 150-200° C., which satisfies the following formula (1) when W represents the volume resistivity (Ω·cm) of the electrically conductive coating and X represents its specific gravity:
W≦−1.72×10⁻⁶×X+2.3×10⁻⁵ (1).

9. An electrically conductive coating obtained by coating the electrically conductive composition according to claim 1 followed by heating for about 30 minutes at about 150-200° C., which satisfies the following formula (2) when Y represents the number of pores of about 100 nm or larger present in a surface area of about 10 μm×10 μm on the uppermost surface of the electrically conductive coating, and Z represents the heating temperature (° C.):
Y<−46.08·Z+10112 (2).

10. An electrically conductive composition according to claim 3, wherein the average particle diameter of the particulate silver compound is about 0.5 μm or less.

11. An electrically conductive composition according to claim 3, wherein the particulate silver compound is produced by a liquid phase method in which silver oxide is obtained by reacting an aqueous alkaline solution with the product of the reaction between a silver compound and an aqueous silver nitrate solution.

12. An electrically conductive composition according to claim 11, wherein the particulate silver compound is produced by a liquid phase method and a dispersion stabilizer is added to the aqueous alkaline solution.

13. An electrically conductive composition according to claim 1, wherein a vapor phase method is used to obtain a particulate silver compound having an average particle diameter of about 0.1 μm or less by synthesizing silver oxide by heating a silver halide and oxygen in the vapor phase followed by thermal oxidation.

14. An electrically conductive composition according to claim 1, wherein the amount of reducing agent used is about 20 moles or less with respect to about 1 mole of particulate silver compound.

15. An electrically conductive composition according to claim 14, wherein the amount of reducing agent used is about 0.5-10 moles with respect to about 1 mole of particulate silver compound.

16. An electrically conductive composition according to claim 1, wherein a dispersion medium is used to disperse or dissolve the particulate silver compound and reducing agent and obtain a liquid electrically conductive composition.

17. An electrically conductive composition according to claim 16, wherein an organic solvent or an alcohol is used as the dispersion medium.

18. An electrically conductive composition according to claim 1, wherein when the reducing agent is a liquid and the particulate silver compound is dispersed, the reducing agent also serves as a dispersion medium.

19. An electrically conductive composition according to claim 1, wherein secondary aggregation of the particulate silver composition is prevented by adding a dispersant.

20. An electrically conductive composition according to claim 19, wherein the dispersant is selected from the group consisting of hydroxypropyl cellulose, polyvinyl pyrrolidone and polyvinyl alcohol, and the amount of the dispersant used is about 0-300 parts by weight to about 100 parts by weight of particulate silver compound.

21. An electrically conductive composition according to claim 1, wherein the viscosity of the electrically conductive composition is about 30-300 poise.

22. An electrically conductive coating obtained by coating the electrically conductive composition according to claim 1 followed by heating, wherein the particulate silver compound is reduced, and the reduced metallic silver particles form a continuous, metallic silver thin coating.
